(19) United States
(12) Patent Application Publication
(10) Pub. No.: US 2006/0149998 A1
(43) Pub. Date: Jul. 6, 2006

(54) Method of writing and restoring preservation data

(75) Inventor: Thierry Prigent, Saint-Helene (FR)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/295,228

(22) Filed: Dec. 6, 2005

(30) Foreign Application Priority Data
Dec. 10, 2004 (FR) 0413145

(51) Int. Cl. G06F 11/00

(52) U.S. Cl. 714/6

(57) ABSTRACT

A method of writing preservation data onto a photographic medium (10) wherein the preservation data are converted into color and/or exposure energy values and wherein, for each preservation data item, at least one writing range (15) of the medium is exposed with the energy and/or color corresponding to said preservation data item, characterized in that the writing ranges (15) are arranged in rows (16) and columns (18), such as in a matrix (12), and in that each row and column of the matrix is linked to at least one control range (24, 26) exposed with an energy and/or color corresponding to at least one control data item created from the preservation data linked to the writing ranges, of the row and column, respectively.

### CROSS REFERENCE TO RELATED APPLICATIONS

This application is based on French application 0413145 filed Dec. 10, 2004.

### FIELD OF THE INVENTION

The present invention relates to a method of writing and restoring preservation data. Preservation data means data that are intended to be recorded on a medium for long-term preservation purposes. This is for example archive data or backup data. The invention has applications for the preservation of any type of data, and in particular image or photographic data.

### BACKGROUND OF THE INVENTION

Whatever the chemical, electronic, magnetic or mechanical nature of the recording, the lifespan of the recorded data may be affected by many factors of data alteration or loss. These include especially the deterioration of the recording medium, the fading or modification of the recording marks, the obsolescence of the reading instruments, or, more simply, the impossibility of identifying the recording.

As an illustration, a photograph recorded analogically on film may suffer from chemical or atmospheric attack, exposure to light or even mechanical deterioration. This is shown by localized or overall modification of the colors or densities, by spots, scratches or tears.

Although a number of characteristics of the original image can be restored, the exact reproduction of the image data soon becomes impossible.

The recording of digital data on magnetic or optical media is also vulnerable. Just like analog recording, this is sensitive to thermal, mechanical or light attack.

The reproduction of digital data is also dependent on the availability of equipment capable of reading the data in the format used at the time of its writing. The rapid obsolescence of formats thus becomes an additional limit to the preservation lifespan. Finally, digital data do not generally appear in a directly meaningful form, which prevents visual recognition of the contents. For example, a silver photograph, even altered, remains recognizable whereas the contents of an optical disc remain illegible for lack of suitable equipment.

### SUMMARY OF THE INVENTION

It is the object of the invention to propose a method of writing and restoring preservation data that enables the lifespan of the recordings to be increased.

It is also an object to propose a means of identifying altered data and reproducing the original recorded data by restoring the altered data.

In a way more specific to image preservation, it is also an object to propose a method of writing that enables meaningful contents of the preservation data to be conserved and the resistance of the recording to localized changes to be increased.

To achieve these objects, the invention has more precisely for object a method of writing preservation data onto a photographic medium in which the preservation data are converted into values of color and/or exposure energy and in which, for each item of preservation data, at least one writing range of the medium is exposed with the energy and/or color corresponding to said item of preservation data. According to the invention, the writing ranges are arranged in rows and columns, such as in a matrix. Furthermore, each row and column of the matrix is linked to at least one control range exposed with an energy and/or color corresponding to at least one control data item created from the preservation data linked to the writing ranges of the row and column, respectively.

In the following description “control range” means a writing range whose density and/or color corresponds to the coding of a control data item. Similarly, “data item range” means a writing range corresponding to a preservation data item. In a system of writing by pixels, each pixel can constitute a writing range. The ranges can be also formed by several pixels.

The photographic medium used for the writing method can comprise any type of medium enabling data coded in terms of color and/or density to be recorded. For example, silver photographic films or thermal or ink jet printing media can constitute photographic medium according to the invention. In the case of ink jet printing, the exposure energy is included as the density of the dye used to form the ranges.

The control ranges are written in the same way as the data ranges. Further, each preservation data item constitutes a parameter for creating at least two control data items linked respectively to the row and column at the intersection of which the corresponding data item is found.

It should be noted that the control ranges occupy a very small area of the medium compared with that of the data ranges.

The control data can be coded in a limited number of control ranges, for example between one and ten, while they are linked to rows or columns that can be formed by several hundreds or thousands of data ranges. The presence of the control ranges thus only increases the required recording area by a small amount.

The linking of the control ranges to the data ranges enables the simultaneous conserving of the preservation data and, in a sense, a signature of their validity. Besides, the linking of the control ranges to the rows and columns of the matrix of data ranges enables the coordinates of defective or altered ranges to be easily found. The characteristics of the writing method have yet other advantages in relation to data reproduction. This will be described below.

The control data can be created in various ways from the preservation data of the rows and columns. Very simply put, this can be linear combinations of the preservation data of the rows and columns. It can also be proof data or data respecting an arithmetic congruence of the preservation data of the rows and columns.

A very simple example is casting out nines. For information, one can refer to “Digital Signatures: How They Work” by Jeff Prosise, PC Magazine, Apr. 9, 1996.

In a more sophisticated way, the control data can be created from intermediate data, themselves obtained by converting the preservation data using a transformation operand. The transformation can a be Fourier transformation, a convolution, or any other transformation in the form of an application.

For example, a convolution can be made between a matrix whose rows and columns contain the preservation data in the same order as the writing ranges, and a matrix operand, also called “kernel” or convolution matrix.

An indication of the transformation operations made to create the control data from the preservation data is preferably recorded in a directly legible way by a person onto the photographic medium. It can also be linked to it by any other means, that make it available at the time of reading.

The preservation data can be digital data of any type. It can also be control data of another set of preservation data.

In the special case where the preservation data are image data, the data ranges are preferably arranged to enable visual recognition of the image.

Visual recognition of the image does not require a faithful reproduction of the image pixels. Indeed, the writing ranges have just to keep luminance information and an order in the matrix, dictated by the luminance information and the order of the pixels of the image to be kept. In particular, recognition is possible despite strong sub-sampling. In other words, a strictly one-to-one relation between the data ranges and the pixels of the image is not essential.

It is thus possible to arrange the data ranges in multiple matrices that each have the control ranges linked to their rows and columns. The data ranges of the various matrices can correspond to sub-samplings of the image, to various color layers of the image and/or again in luminance and chrominance components of the image. The latter solution is particularly recommended for the images of a video stream.

The preservation of the possibility of direct visual recognition of the semantic content of the recording greatly facilitates the management of the preserved data, including in the absence of suitable reading equipment.

The invention also relates to a method of identification and restoration of altered or erroneous preservation data among data written according to the previously described method.

The identification of erroneous data takes place according to a method in which:

a) the preservation data and control data linked to writing ranges are created by reading and decoding data ranges and control ranges,

b) new control data are calculated corresponding to the preservation data created in step a),

c) the control data created in step a) and the new control data calculated in step b) are compared, and

d) preservation data, corresponding to the writing ranges located at the intersection respectively of a row and column linked to the control ranges whose control data is different from the new control data, are retained as erroneous data in the comparison step c).

The new control data are calculated by using the same functions or algorithms as those used for the calculation of the control data at the time of writing. The functions or algorithms, or at least their mathematical expression can be reproduced analogically or coded onto the same photographic medium, to be recognized at the time of reading.

As soon as the altered data are identified, it is possible to use all the preservation and control data written according to the above-mentioned writing method to restore the altered data. The restoration takes place according to a method in which:

for each erroneous data item, at least one equation is created in which the non-erroneous data and the control data of the row and/or column corresponding to the erroneous data item are parameters, and in which the altered data item is an unknown, so as to form a system of equations, and

the restored data are calculated by arithmetic resolution of the system of equations.

The erroneous data are then replaced by the restored data.

When the data ranges are arranged in multiple matrices, identification of the erroneous data and their restoration takes place separately for each matrix, by using the control data of the respective rows and columns. Finally, the preservation data are recombined from the restored data and the non-erroneous data of each matrix.

The combination of data from the various matrices can be ordered either by information on range order or by visual recognition of an image, when the data are image data.

The invention also relates to a photographic medium comprising at least one matrix of data ranges and control ranges linked to the rows and columns of the matrix, in which the control ranges have colors and/or densities that are respectively one-to-one functions of the colors and/or densities of the writing ranges of the corresponding rows and columns.

The medium can also comprise a sensitometric control, recorded to cover a range of densities and/or colors used for writing the data ranges and control ranges. The sensitometric control comprises, for example, multiple ranges of increasing densities so that each range follows the same pattern. A continuous density gradient can be also used. The control can be provided in various colors. It enables the measured density values to be linked to energies and thus to digital values of the recorded data.

The sensitometric control is written onto the same medium as the data ranges and control ranges. The data ranges, control ranges and sensitometric control ranges thus undergo the same ageing and the same environmental attacks. An overall correction of the densities or colors of data or control ranges can thus be made by using the sensitometric control. For information, one can refer for example to U.S Pat. No. 6,810,209.

Other characteristics and advantages of the invention will appear in the following description, with reference to the figures in the appended drawings. This description is given purely as an illustration and is not limiting.

### BRIEF DESCRIPTION OF THE INVENTION

FIG. 1 is a schematic representation of a recording of a data set illustrating an implementation of the invention method.

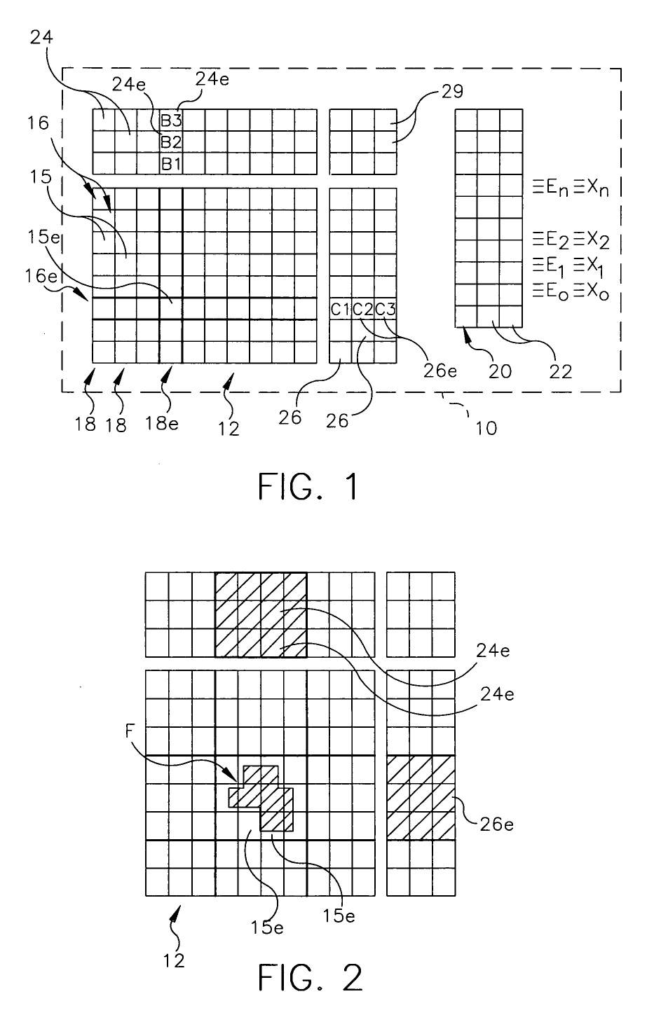

FIG. 2 is a schematic representation of a recording of a data set according to the invention illustrating data restoration.

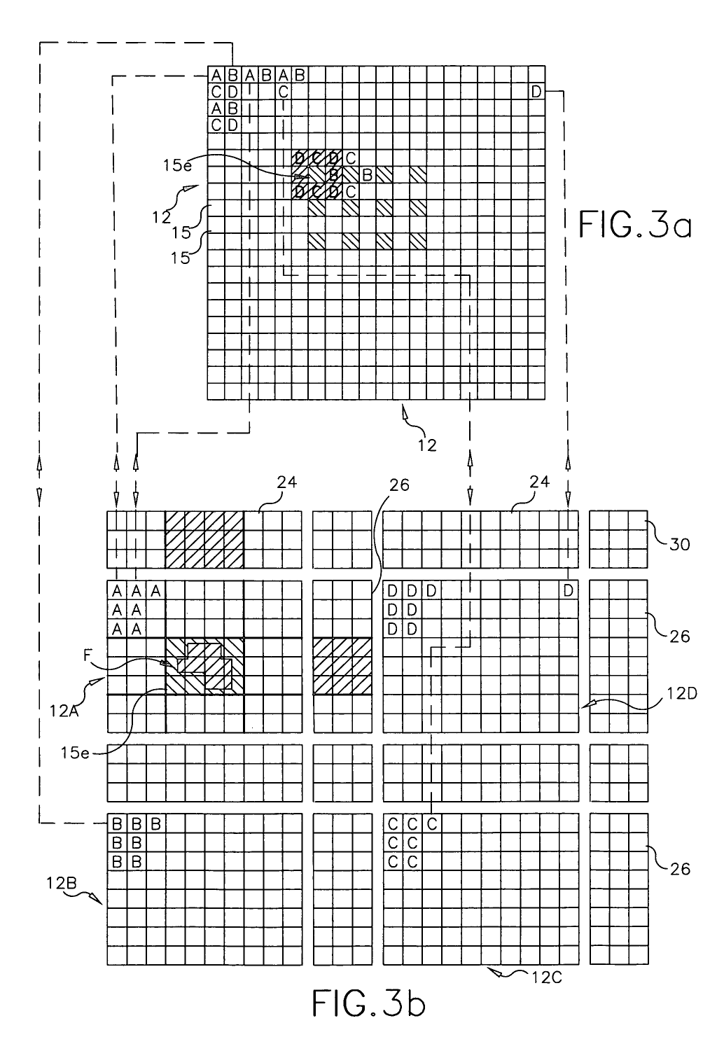

FIGS. 3a and 3b are schematic representations of the pixels of an image capable of being recorded according to the invention and show a particular recording of image data.

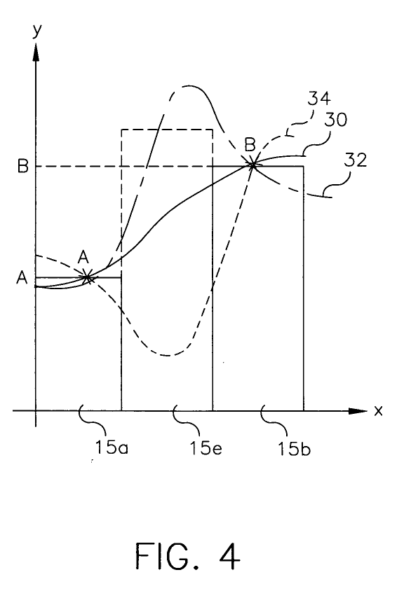

FIG. 4 is a graph illustrating the restoration of erroneous data corresponding to the altered pixels of an image.

### DETAILED DESCRIPTION OF THE INVENTION

FIG. 1 shows a photographic medium 10, in this case a silver film, on which multiple ranges 15 are recorded. The ranges are organized in a matrix 12, that is, in a regular arrangement of rows 16 and columns 18.

The ranges 15, shown by data ranges, have optical densities, and possibly colors, that code values of the recorded preservation data. Each range, taken individually, has a uniform color and density. More precisely, there is a one-to-one relationship between a range of values that can take the preservation data and a range of densities and/or colors for writing the data ranges. The densities are dictated by the energy of a range writing beam. For example, the preservation data can be coded in 256 gray levels and three colors (RGB). In an implementation described here, a single range is linked to each preservation data item. However, it is possible to link several ranges to the same data item when the digital coding of the data item is expressed in a base with higher rank than the number of gray levels planned for the recording.

Also recorded on the same medium is a sensitometric control 20 with ranges 22 that cover the colors and density range of the preservation data ranges. The sensitometric control can directly link a density to a writing energy E₀, E₁, E₂ . . . Eₙ and to a data value X₀, X₁, X₂ . . . Xₙ. Indeed, these amounts are linked by a one-to-one relationship. This takes into account the medium's response curve (curve S for a photographic medium) that links the densities to the exposure energies.

The function of the sensitometric control is no directly linked to the invention method. However, its use lies in facilitating the calibration of the reading instruments used during the restoration of the recorded data.

In the case of FIG. 1, three control ranges 24 are linked to each row and three control ranges 26 are linked to each column of the matrix 12. The control ranges correspond to one or more control data items respectively calculated using the preservation data of the corresponding rows or columns. The coding of the control data into control ranges is identical to that of preservation data into data ranges. Given that that the ranges enable information to be coded on 8 bits, three control ranges can be used to code a control data item in the form of a 24-bit word. It is also possible to link several different control data items to the rows and columns, respectively calculated in a different way and each coded in one or more control ranges.

As previously mentioned, the control data are, for example, linear combinations, or functions of proof of preservation data.

When reading the medium 10, all the data ranges and control ranges are scanned. The density and/or color values are then converted into digital values to reproduce the preservation data and control data. By using the same equations or functions of proof, it is possible to create new control data from the preservation data created following reading of the medium.

These new control data are then compared with the control data coded by control ranges 16, 18 of the medium. Non-matching between the control data created by reading the control ranges and those created by calculation from the preservation data points to the presence in the row or column of at least one altered writing range and thus of preservation data that is also altered.

In the example of FIG. 1, we assume that the control data created from the preservation data of row 16e do not match the data C1, C2, C3 created from the linked control ranges 24e. In the same way, we assume that the control data created from the preservation data of row 18e do not match the data B1, B2, B3 created from the linked control ranges 26e. It is deducted from this that the preservation data created by reading data range 15e, which is at the intersection of rows and columns 16e and 18e, is erroneous. The rows and columns for which a match of the control data is not found are still indicated by erroneous line 16e or erroneous column 18e.

Although not very probable because of a generally small area occupied by the control ranges as against the data ranges, it cannot be excluded that a non-match of the control data results not from alteration of a data range, but from the alteration of a control range. However, this option can reasonably be set aside by using several control ranges for each row and column, the various control ranges coding different control data. Further, the presence of an altered control range produces a non-match that only affects one row or one column and not a row and a column.

Finally, additional control ranges 29 can be linked, not to rows and columns of the matrix 12 of preservation data, but to rows and columns of control ranges 24, 26. The additional control ranges can be used to independently verify the accuracy of control ranges 24, 26.

The identification of the altered data ranges, described with reference to FIG. 1, can be completed by a restoration of the resulting erroneous data. However, the restoration can only relate to parts of the matrix because of the fact that the amount of control data is small compared with the amount of preservation data. The small amount of control data compared with the preservation data is dictated by the constraints of recording area available on the medium 10.

In the example of FIG. 1, the erroneous preservation data item corresponding to the erroneous range 15e can be found by resolving one or more equations that link the preservation data of row 16e or column 18e respectively to the control data of the corresponding control ranges 24e and 26e. In these equations, data that are not identified as erroneous are parameters and the data item identified as erroneous is an unknown.

FIG. 2 shows a situation in which a defect F no longer affects an isolated range, but multiple ranges of adjacent data. The defect F indicated in gray on FIG. 1 is for example a spot, dust or a tear on the medium. This means that the preservation data of many rows and many columns are not consistent with the control data of the linked control ranges 24e and 26e.

Given the above-mentioned erroneous data identification method, a set of data ranges 15e is selected. It can be observed on the figure that certain data ranges are not necessarily altered by the defect F but are however selected as such because they are found at the intersection of an erroneous row and column.

All the ranges 15e considered as altered appear in the form of an R×C matrix, where R and C indicate the number of successive rows and the number of successive columns respectively affected by the defect and consequently having a control range with a control data item not matching the new control data item created from the preservation data.

When the control data are linear combinations of the preservation data, each row and column gives an equation in which the preservation data considered as erroneous and the control data item are parameters and in which the erroneous data constitute variables.

Thus a matrix of R×C erroneous ranges generates unknown R×C and R+C equations when a single control range and control data item are linked to each row and column. The preservation data corresponding to the altered ranges can be reproduced if the number of unknowns does not exceed the number of equations.

By setting aside the special case of a scratch whose width does not exceed that of a single writing range, the data can be reproduced if the following inequality is verified:
R+C≧R×C

This means that, in this case, it is not possible to restore the erroneous data of a defect with dimension greater than 2×2 writing ranges.

The area of a defect capable of being corrected can be increased by increasing the amount of control data, and thus the number of control ranges linked to the rows and columns of preservation data.

For example, if an amount N of control data are linked to the rows and columns, restoration can take place when:
N×(R+C)≧R×C

Thus a defect can occupy an area of 5×6 writing ranges for N=3.

To extend the possibilities of restoring erroneous data, one perfection consists in using for each row and column several control data items that result from preservation data and/or intermediate data obtained by convolution of the preservation data by a transformation operand. For example, a convolution product is made between a digital matrix that includes the preservation data in the order of the ranges they are linked to, by an operand in the form of a kernel K×K. The values of the kernel are preferably recorded with the preservation data to make them available during the reading. The convolution product gives the intermediate values, in this case a digital matrix of intermediate data of the same dimension as the preservation data matrix. Then, control data is calculated from the intermediate data, in a very similar way to the calculation of control data from the preservation data. The control data obtained from the intermediate data are written in the form of control ranges linked to rows and columns.

The number of equations it is possible to write becomes (R+K−1)+(C+K−1).

Restoration of erroneous data is possible when the following relationship is verified:
(R+C)+2×(K−1)≧R×C

By using two control data items per row and column, and by using a set of intermediate data, it is possible to restore the erroneous data of a defect of 7×7 writing ranges or 18×18 writing ranges by using an matrix operand (kernel) of size 11×11 and 127×127, respectively. It may be noted that the size of the operands and the quantity of data that they represent are much lower than those of the data matrices capable of being written on the medium. For comparison, a data matrix corresponding to a 52-megabyte image has 4096×3072 preservation data items.

Parts (a) and (b) of FIG. 3 show a particular implementation of the writing method enabling the data restoration capacities to be increased when these correspond to an image or a photograph. Part (a) of FIG. 3 shows a matrix 12 of data ranges 15 that correspond, for example, to image data. The ranges of the matrix can be recorded together with the control ranges in the way already described with reference to FIG. 1.

The data ranges or the data itself can also be distributed into several subgroups, according to their position in the initial matrix. The subgroups can follow an order of repetition. Thus on part (a) of FIG. 3, ranges A, B, C and D in a quaternary alternating order with two rows can be distinguished.

Part (b) of FIG. 3 shows a possibility of writing ranges onto a medium in which a matrix of data ranges 12A, 12B, 12C and 12D is linked to each range subgroup, by nevertheless following the order of ranges within each subgroup. In other words, matrix 12A groups together all the data “A” of the matrix of part (a) of FIG. 3, and so on for the data “B”, “C” and “D”.

When the data corresponding to the ranges of FIG. 3 are image data, the data ranges 15 can be comprised of pixels. In this case, each of the matrices 12A, 12B, 12C and 12D of part (b) of the figure represents an image identical to that of part (a) but sub-sampled by a factor 4. This characteristic is very useful because it enables recognition of the image in each of the matrices at any time, and without particular equipment.

On FIG. 3, the iconic content of the image is eliminated for reasons of clarity. On the other hand, double-arrows in broken line give examples of correspondence between the ranges of parts (a) and (b) of the figure.

Further, each matrix, 12A, 12B, 12C, 12D, is linked to control ranges 24, 26 comparable to those of FIG. 1.

During the reading, restoration of the data can take place in two steps. A first step consists in identifying and restoring the data in the way previously described, by using the data of the control ranges. After this first step, reconstruction of the original matrix takes place. This reconstruction takes place by juxtaposing ranges or pixels coming alternately from four matrices 12A, 12B, 12C and 12D by following the quaternary order that enabled them to be created.

On part (b) of FIG. 3, we assume that a defect F affects a number of ranges 15e of the matrix 12A that could not be restored. It can be observed that the adjacent ranges of erroneous data 15e of part (b) of FIG. 3, due to defect F are separated on the reconstructed original matrix, which corresponds to that of part (a) of FIG. 3. Indeed, on the matrix of data ranges of part (a) of FIG. 3 each erroneous range 15e is surrounded with non-erroneous ranges coming from the other matrices 12B, 12C and 12D of part (b) of FIG. 3.

The second step of restoration of the erroneous data can then occur by taking advantage of the fact that an erroneous range is surrounded with non-erroneous ranges. The erroneous data item can be created as an average or a particular combination of data from the surrounding non-erroneous ranges.

An illustration of one possibility of the restoration of erroneous image data from ranges or pixels in the neighborhood of the corresponding altered ranges is given in European Patent EP 0778543 B1.

Another illustration is given by FIG. 4. On FIG. 4 the values of data ranges corresponding to adjacent pixels 15a, 15e 15b are represented in the form of a graph. The abscissa of the graph corresponds to the rank of the successive data ranges taken in direction x merged with a row, column, or a diagonal of a recording matrix as previously described. The ordinate gives the value of the data. By simplification, only one set of three ranges is selected, in which an altered range 15e is surrounded on either side by two unaltered ranges 15a and 15b. Thus we assume that the values of the data linked to ranges 15a and 15b are known and not erroneous, and that the value of range 15e is to be restored.

The known values of the surrounding ranges enable parametered surfaces or curves to be created such as Bezier or Hermit surfaces or curves that pass by points A, B corresponding to the values of the known ranges. These are 3-degree or higher surfaces. On the figure, the parametered surfaces are simply represented by curves 30, 32, 34 whose shape varies according to a parameter, and which pass by the known points A and B. The curves or surfaces can take account of the values at the known points as well as the slope or tangent at these points. The “points” correspond here to pixels or, more generally, to data ranges.

Different values of the parameter enable the development of various probable values of the range to be restored. The various possible values of the ranges to be restored are used with the known non-erroneous values of the data ranges found on the same row or column of the matrix to calculate possible values of the control data of the row or column.

Finally, selected as values of the restored ranges are those ranges that give the parametered curves that give control data closest to those corresponding to the control ranges of the affected rows or columns. This is restored data.

The restoration as described with reference to FIG. 4 enables an estimate of the erroneous data to be obtained. It thus differs from the previously described restoration, with reference to FIG. 2, which enables the erroneous data to be replaced by exact data resulting from the function that links the preservation data with the control data.

1. A method of writing preservation data onto a photographic medium comprising:
converting the preservation data into at least one of color and exposure energy values;
for each item of preservation data, exposing at least one writing range of the medium with the at least one of energy and color corresponding to said preservation data item;
arranging the writing ranges in rows and columns in a matrix; and
linking each row and column of the matrix to at least one control range exposed with at least one of an energy and color corresponding to at least one control data item created from the preservation data linked to the writing ranges.

2. A method according to claim 1, wherein the control data of each row and column are respectively linear combinations of the preservation data linked to ranges of said rows and columns.

3. A method according to claim 1, wherein the control data of each row and column are respectively proofs.

4. A method according to claim 3, wherein the proofs follow an arithmetic congruence of the preservation data linked to the ranges of said rows and columns.

5. A method according to claim 1, wherein the control data of each row and column are created from intermediate data obtained by making a transformation of the preservation data linked to the ranges of said rows and columns by a transformation operand.

6. A method according to claim 1, wherein the preservation data are data corresponding to the pixels of an image and the writing ranges are arranged to enable visual recognition of the image.

7. A method according to claim 1, wherein the writing ranges are arranged in multiple matrices and at least one control range is linked to each row and column of each matrix.

8. A method according to claim 7, wherein the writing ranges of each matrix constitute a sub-sampling of the image.

9. A method according to claim 1, wherein the preservation data are themselves the control data of other preservation data.

10. A method of identification of erroneous preservation data among data written according to claim 1, comprising:
a) creating the linked preservation data and control data by reading and decoding data writing ranges and control ranges;
b) calculating new control data corresponding to the preservation data created in step a);
c) comparing the control data created in step a) and the new control data; and
d) retaining as erroneous data the preservation data corresponding to the writing ranges located at the intersection of a row and column respectively linked to the control ranges when the control data is different from the new control data.

11. A method of restoring erroneous preservation data written according to the method of claim 1, comprising:
a) for each item of erroneous data, creating at least one equation with non-erroneous data and control data of the row and column corresponding to the erroneous data item being parameters and the erroneous data item being an unknown, thereby forming a system of equations; and
b) calculating restored data using an arithmetic resolution of the system of equations.

12. A method of restoration, according to claim 11, the preservation data of an image being arranged in multiple matrices further comprising:
restoring the erroneous data of each matrix using the control data of the rows and columns of the respective matrices; and
recombining the image data based on the restored data and the non-erroneous data from each of the matrices.

13. A method according to claim 11, wherein the restoration of erroneous data of altered ranges is also carried out using the non-erroneous data of unaltered ranges neighboring the altered ranges.

14. A photographic medium comprising:
at least one matrix of data exposure ranges and control ranges linked to rows and columns of the matrix, wherein the control ranges have at least one of colors and densities that are respectively one-to-one functions of at least one of colors and densities of the writing ranges of the corresponding rows and columns.

15. A photographic medium according to claim 14, further comprising:
a sensitometric control covering a range of the at least one of colors and densities of the writing ranges and control ranges.
